(19) United States
(12) Patent Application Publication
(10) Pub. No.: US 2021/0016400 A1
(43) Pub. Date: Jan. 21, 2021

(54) WORK SUPPORTING AND ROTATING APPARATUS

(71) Applicant: Dalmac Enterprises PTY LTD, Palm Beach, Queensland (AU)

(72) Inventor: David Daly, Palm Beach, Queensland (AU)

(73) Assignee: Dalmac Enterprises PTY LTD, Palm Beach, Queensland (AU)

(21) Appl. No.: 16/980,641

(22) PCT Filed: Mar. 11, 2019
(86) PCT No.: PCT/AU2019/050216

§ 371 Date: Sep. 14, 2020

(30) Foreign Application Priority Data
Mar. 15, 2018 (AU) 2018900849

(51) Int. Cl. B23Q 1/76; B23K 37/053; B24B 41/06

(52) U.S. Cl. CPC B23Q 1/763; B24B 41/067; B23K 37/0538

(57) ABSTRACT

This invention relates in general to a portable work supporting and rotating apparatus for rotatable support of elongate workpieces of various diameters to be worked. The device having a longitudinally extending base frame with a fixed member and a movable member being disposed in generally parallel and spaced relation. A plurality of rollers are journaled on the fixed and movable members to rotatably support the elongated workpieces axially parallel to said rollers between the fixed and movable members. A means for moving the movable member in a transverse relationship with the fixed member is provided to increase or decrease a space between the fixed and movable members. A drive unit is operatively connected to one of the plurality of rollers permitting the workpiece to be rotated about a longitudinal axis.

### FIELD OF THE INVENTION

This invention relates in general to a portable work supporting and rotating apparatus. In particular, the invention relates to an apparatus adapted to support and rotate pipe sections or other elongated generally cylindrical objects during cutting, grinding, machining or similar work of the pipes.

### BACKGROUND OF THE INVENTION

It should be noted that reference to the prior art herein is not to be taken as an acknowledgement that such prior art constitutes common general knowledge in the art.

A pipe is a tubular section or hollow cylinder, usually but not necessarily of circular cross-section, used mainly to convey substances which can flow, such as liquids and gases (fluids), slurries, powders and masses of small solids. Typically a pipe implies a level of rigidity and permanence, and can made out of many types of material including ceramic, glass, fiberglass, many metals, concrete and plastic. Concrete pipe in particular is utilised for low-pressure applications such as gravity flow or drainage. Pipes for sewage are still predominantly made from concrete or reinforced concrete for large-diameter concrete pipes. Concrete or reinforced concrete pipe can be used in many types of construction, and is often used in the gravity-flow transport of storm water. Usually such pipe will have a receiving bell or a stepped fitting, with various sealing methods applied at installation.

Concrete pipe is known as a rigid pipe that provides both structure and conduit with steel reinforcement in the concrete pipe adds significantly to its inherent strength. The steel reinforcement is shaped into cages, using precision measures to fabricate a steel mesh by automatic cage welding machines. From time to time it will be necessary to cut pipes and install fittings and in particular perform these tasks at the worksite. These pipes can vary in weight from 200 kg up to more than 8000 kg, have a diameter from 200 mm up to more than 3000 mm and are provided in approximately 2.4 m lengths. As described above they are substantially circular in cross-section but may have a bell end for attachment purposes.

The terms “pipe roll”, “pipe roller” and “pipe rotator” as used herein are intended to mean support devices having roll assemblies to provide rotatable support for pipes, poles and any other object having a cylindrical outer peripheral surface and which is intended to be rotatably supported generally horizontally to enable various work to be performed on it. Various types of devices for rotatable support of pipe and various other elongate objects of round cross-sectional configuration have been developed. These support devices, typically referred to as pipe rolls and supports, generally comprise a support structure having a roll support member at the upper portion on which is mounted a pair of rollers that provide rotatable support for the pipe or other object being supported.

Due to the weight and size of these pipes and in particular concrete pipes, any work support or rotating apparatus must be able to at least safely support such devices. In particular, and at it extremes, a three metre diameter concrete pipe which weighs approximately 5000 kg. The present known devices which are designed to handle such pipes are permanently fixed and typically have a bulky motor drive which involves connection to three phase power within a workshop. They are not designed to be portable and used at a worksite. This also means that the user must assemble the manufactured work pieces always in the same work area; in fact it is very difficult and anti-economical to move the positioners to another work area within a same factory, or directly in a building yard, as this could require the displacement of a whole work line. Positioning and perfect alignment of the circular sections is made difficult involving the use of conventional systems such as wedges, cranes and chains.

Some other known devices have been devised which provide for the positioning and processing of elongated circular work pieces having medium or large diameters and lengths. These devices have two separated support points, in which each positioner includes a base frame provided with idle rolls at each end of the manufactured work piece to be processed. These devices are time consuming to set up and must be synchronized to operate together to ensure the workpiece is moved at the same time as it is turned or rotated.

Clearly it would be advantageous if a work supporting and rotating apparatus could be devised that helped to at least ameliorate some of the shortcomings described above. In particular, it would be beneficial to provide an apparatus adapted to support and rotate pipe sections or other elongated generally cylindrical objects during cutting, grinding, machining or similar work of the pipes and the like or at least provide the public with a useful choice.

### SUMMARY OF THE INVENTION

The present invention has been developed to provide an adjustable workpiece positioning device which is adapted to support and rotate pipe sections or other elongated generally cylindrical objects during cutting, grinding, machining or similar work of the pipes. The device is able to be easily transported to the worksite and is easy to set up at the worksite.

In accordance with a first aspect, the present invention provides an adjustable workpiece positioning device for rotatable support of elongate workpieces to be worked, the device comprising: a longitudinally extending base frame having a fixed member and a movable member being disposed in generally parallel and spaced relation; a plurality of rollers journaled on the fixed and movable members to rotatably support the elongated workpieces axially parallel to said rollers between the fixed and movable members; a means for moving the movable member in a transverse relationship with the fixed member to increase or decrease a space between the fixed and movable members, thereby permitting the workpieces of various diameters to be rotatingly supported by the plurality of rollers; and a drive unit operatively connected to one of the plurality of rollers, the drive unit permitting the workpiece to be rotated about a longitudinal axis while being supported on the plurality of rollers.

Preferably, pairs of the plurality of rollers may be located in corresponding adjacent positions on each of the fixed and movable members. Each pair of the plurality of rollers may have one roller on the fixed member and one roller on the movable member.

Preferably, the plurality of rollers on the fixed member may rotate about a first parallel axis and the plurality of rollers on the movable member may rotate about a second parallel axis. The first and second parallel axes of the plurality of rollers may be positioned either side of and running parallel with the longitudinal axis of the workpiece.

Preferably, the plurality of rollers may be selected from any one of a cast iron or steel caster wheel, a cast iron or steel wheel, a polyurethane plastic wheel or a urethane on cast iron wheel.

Preferably, each one of the plurality of rollers may be mounted to freely rotate in a position located substantially above each of the fixed and movable members. Each roller mounting may comprise a pair of spaced apart mounting plates forming a carriage for the rollers, each mounting plate having a central aperture for receiving an axle bolt for rotatably mounting the roller to the mounting plates.

Preferably, at least one of the plurality of rollers may have a manually operable roll brake for stopping rotation of the roller thereof and selectively rotatably positioning the elongate workpiece being rotatably supported thereby. The manually operable roll brake may be applied to one of the rollers located on an end of either the fixed or movable members.

Preferably, the drive unit may be operatively connected to at least one of the plurality of rollers on the fixed member. Preferably, the drive unit may further comprise at least one drive wheel and an associated drive shaft. The drive wheel may be operatively connected to the roller by at least tensioning device mounted between the roller mounting and a drive wheel mounting plate.

Alternatively, the drive wheel may be operatively connected to the roller by a tensioning device mounted on either side of the pair of roller mounting plates and a corresponding pair of drive wheel mounting plates.

Preferably, the tensioning device may be a tension spring.

Preferably, each one of the plurality of rollers on the fixed member may have an operatively connected drive wheel and associated drive shaft which interconnects each drive wheel of the drive unit.

Preferably, the drive shaft may be rotatably supported in the drive wheel mounting plate. The drive unit drive shaft may have a drive attachment mechanism located on an end of the drive shaft. The drive attachment mechanism may be adapted to be mechanically driven permitting the workpiece to be rotated about a longitudinal axis while being supported on the plurality of rollers. Preferably, the mechanical drive may be an electric or hydraulic motor.

Alternatively, the drive attachment mechanism may be a socket for receiving a socket wrench to allow a user to drive the drive unit permitting the workpiece to be rotated about a longitudinal axis while being supported on the plurality of rollers.

Preferably, the means for moving the movable member may comprise a pair of arms extending perpendicular from the fixed member, each arm having a plurality of apertures extending along the length of each arm and adapted for receiving a locating pin to be secured through a corresponding aperture in the movable member, the movable member is adapted to be fixed in positions by the locating pin and whereby moving the movable member towards or away from the fixed member allows variable sizes of elongated workpieces to be handled by the device.

Preferably, the movable member may have an aperture for receiving each arm extending from the fixed member to allow the movable member to slide along the arms and move towards and away from the fixed member. The movable member may further comprise a mounting flange extending around each aperture, the mounting flange having an aperture located in opposing sides of the flange adapted to receive the locating pin to secure the movable member in position on the pair of arms extending from the fixed member.

Preferably, the longitudinally extending base frame may have a substantially flat bottom that permits the placement of the frame on a horizontal supporting surface.

Preferably, the adjustable workpiece positioning device may further comprise a workpiece stop member extending from an end of the fixed or movable members, the workpiece stop member being adapted to engage an end of the elongate workpiece to ensure the workpiece is correctly positioned on the device. Alternatively, the workpiece stop member may extend from an end of the fixed and movable members.

Preferably, a length which the workpiece stop member may extend from the end of the fixed and movable members is adjustable. The workpiece stop member may further comprise a height adjustable spigot adapted to receive a flanged end of the elongate workpiece. The spigot may have a threaded shaft which is received within a threaded socket of the workpiece stop member and is adapted to be screwed in and out to accommodate different sized flanged ends.

Preferably, the adjustable workpiece positioning device may further comprise at least one lifting point attached to the fixed or movable members. Alternatively, the adjustable workpiece positioning device may further comprise two lifting points located on an external side of both the fixed and movable members. The lifting points may comprise a load ring fixedly attached to the fixed and movable members.

Preferably, the elongate workpiece may have a substantially circular cross-section. Preferably, the elongate workpiece may be selected from any one of a ceramic pipe, a glass pipe, a fiberglass pipe, a metal pipe, a concrete pipe or a plastic pipe.

Preferably, the elongate workpiece may be a concrete pipe having a weight in the range of 200 kg up to more than 8000 kg, having a diameter from 200 mm up to more than 3000 mm and are provided in a length of approximately 2.4 m.

In accordance with a further aspect, the present invention provides an adjustable workpiece positioning device for rotatable support of extended elongate workpieces to be worked, the device comprising: a first adjustable workpiece positioning device comprising: a longitudinally extending base frame having a fixed member and a movable member being disposed in generally parallel and spaced relation; a plurality of rollers journaled on the fixed and movable members to rotatably support the elongated workpieces axially parallel to said rollers between the fixed and movable members; a means for moving the movable member in a transverse relationship with the fixed member to increase or decrease a space between the fixed and movable members, thereby permitting the workpieces of various diameters to be rotatingly supported by the plurality of rollers; and a drive unit operatively connected to one of the plurality of rollers, the drive unit permitting the workpiece to be rotated about a longitudinal axis while being supported on the plurality of rollers; a second adjustable workpiece positioning device comprising: a longitudinally extending base frame having a fixed member and a movable member being disposed in generally parallel and spaced relation; a plurality of rollers journaled on the fixed and movable members to rotatably support the elongated workpieces axially parallel to said rollers between the fixed and movable members; a means for moving the movable member in a transverse relationship with the fixed member to increase or decrease a space between the fixed and movable members, thereby permitting the workpieces of various diameters to be rotatingly supported by the plurality of rollers; and a drive unit operatively connected to one of the plurality of rollers, the drive unit permitting the workpiece to be rotated about a longitudinal axis while being supported on the plurality of rollers; and a connecting member to join the first and second adjustable workpiece positioning devices in an end to end relationship.

Preferably, the first adjustable workpiece positioning device may further comprise the features of the first aspect but excluding the features of the workpiece stop mechanism.

Preferably, the second adjustable workpiece positioning device may further comprise any of the features of the first aspect.

Any one or more of the above embodiments or preferred features can be combined with any one or more of the above aspects.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

FIG. 1 shows a perspective view from one end of the adjustable workpiece positioning device in accordance with an embodiment of the present invention;

FIG. 2 shows a perspective view of the device of FIG. 1 from an opposite end;

FIG. 3 shows a plan end view of the device viewed from FIG. 1;

FIG. 4 shows a plan end view of the device viewed from FIG. 2;

FIG. 5 shows a top plan view of the device of FIG. 1;

FIG. 6 illustrates an enlarged partial view of the fixed member showing the attachment of the arms, main roller and drive wheel;

FIG. 7 shows an enlarged partial view of a fixed member roller and drive wheel;

FIG. 8 shows an end plan view of FIG. 6;

FIG. 9 shows a top plan view of FIG. 7;

FIGS. 10 and 11 show the workpiece stop mechanism in accordance with an embodiment of the present invention;

FIG. 12 illustrates and enlarged partial side view of the movable member on the perpendicular arm;

FIG. 13 illustrates an enlarged side view of the movable member showing the perpendicular arm stop and a lifting point for the device;

FIG. 14 shows the opposite side view of FIG. 12;

FIGS. 15 and 16 illustrate end views of the device in use showing two different diameter pipes being supported for rotation on the device in accordance with an embodiment of the present invention;

FIG. 17 shows the perspective view of FIG. 1 with a cylindrical pipe shown in dashed detail as would be seen in use;

FIGS. 18 and 19 show two exemplary drive mechanisms used to rotate the workpiece of FIG. 17;

FIG. 20 shows a partial side perspective view as viewed from the movable member side of the device in use;

FIG. 21 shows a partial side perspective view as viewed from the fixed member side of the device in use;

FIG. 22 illustrates an enlarged partial end view of the fixed member roller in contact with a portion of a cylindrical workpiece;

FIG. 23 illustrates a perspective view from one end of the adjustable workpiece positioning device in accordance with another embodiment of the present invention; and

FIG. 24 illustrates the use of two adjustable workpiece positioning devices joined to allow the device to receive extended lengths of workpieces in accordance with an embodiment of the present invention.

### DETAILED DESCRIPTION OF THE INVENTION

The following description, given by way of example only, is described in order to provide a more precise understanding of the subject matter of a preferred embodiment or embodiments.

While the workpiece of the present invention will be described with regards to a concrete pipe, it should be appreciated by the person skilled in the art that other workpieces are not excluded by the present invention. For example the following invention can also be used to support and rotate such workpieces as steel pipes, ceramic pipes, glass pipes, fiberglass pipes, many metal pipes and plastic pipes.

For convenience in this specification, a cylindrical object to be supported and rotated will be, called a “workpiece” and the roller apparatus as a whole will be called a “rotator” which is a name by which such apparatus, for large-size workpieces, is known.

The present invention provides a portable work supporting and rotating apparatus to support and rotate pipe sections or other elongated generally cylindrical objects during cutting, grinding, machining or similar work. An advantage of the present invention is the portability which allows a user to perform work on the elongated workpiece at the worksite.

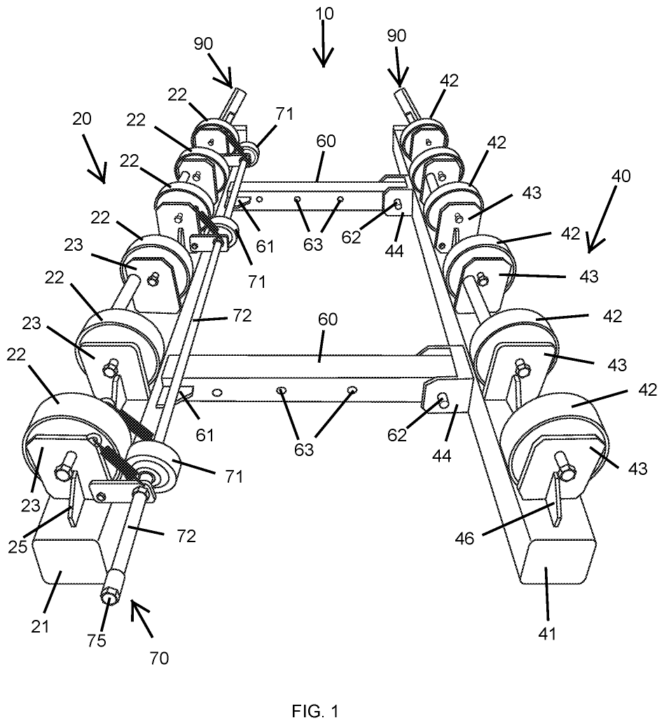

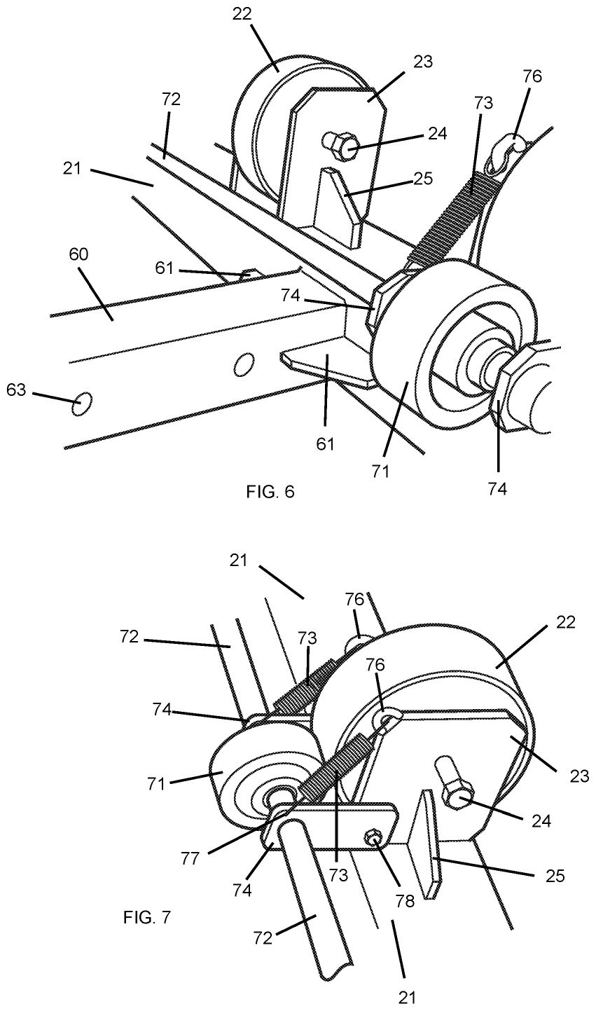

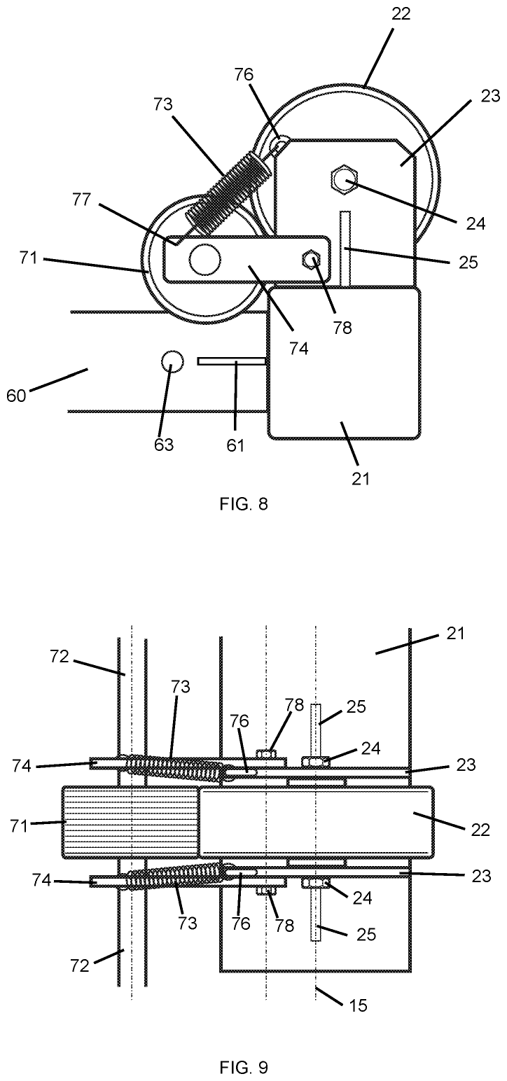

The present invention in its simplest form and as illustrated in FIGS. 1 to 14 provides an adjustable workpiece positioning device 10 for rotatable support of elongate workpieces 11. The device 10 allows the workpiece 11 to be worked while being supported and rotated on the device 10. In relation to being worked, the present invention allows a workpiece 11 to be machined, cut, grinded, welded or any other like process. The adjustable workpiece positioning device 10 has a longitudinally extending base frame having a fixed member 20 and a movable member 40 being disposed in generally parallel and spaced relation to and from each other. A plurality of rollers 22, 42 are journaled on the fixed and movable members 20, 40 to rotatably supporting the elongated workpieces 11 axially parallel to said rollers 22, 42 such the workpiece 11 and the workpiece longitudinal axis 17 is located between the fixed and movable members 20, 40. In order to move the movable member 40 towards and away from the fixed member 20 a means 60 adapted for moving the movable member 40 in a transverse relationship with the fixed member 20 is also provided. The means 60 allow the fixed and movable members 20, 40 to increase or decrease a space therebetween, thereby permitting the workpieces 11 of various diameters to be rotatingly supported by the plurality of rollers 22, 42 on the device 10. A drive unit 70 is also operatively connected to one of the plurality of rollers 22, 42 to allow the workpiece 11 to be rotated about a longitudinal axis while being supported on the plurality of rollers 22, 42 of the device 10.

The adjustable workpiece positioning device 10 consists of two parallel spaced apart members 20, 40. The members 20, 40 are longitudinally extending tube-shaped steel pipes 21, 41. The members 20, 40 are illustrated as having a substantially square cross-sectional shape. However, other shapes could be used provided they had at least one flat bottom surface which allows the members 20, 40 to be placed upon a supporting surface. For example, a rectangular cross-sectioned tube could be used. The flat bottom surface of the members 20, 40 ensures that the adjustable workpiece positioning device 10 can be placed on a levelled worksite to safely support and rotate the workpiece 11. Likewise, different metals may be utilised for the pipes 21, 41 or alternatively for a lightweight device for rotating such items as plastic pipes or metal pipes a hardened plastic pipe 21, 41 may be utilised.

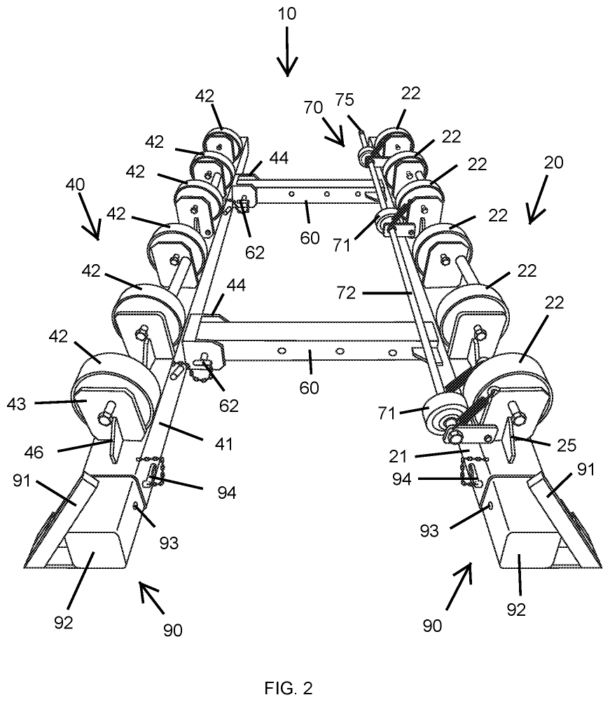

A number of supporting brackets 23, 43 fixed on each respective member 20, 40 form the carriage support for each roller 22, 42. The brackets 23 are fixed to and extend perpendicular from the top surface of pipe 21 of the fixed member 20. Each pair of brackets 23 forms a carriage to rotatably retain the rollers 22. As shown in FIGS. 1 and 2, each pair of brackets 23 is evenly spaced along the top surface of pipe 21 of the fixed member 20 to form carriages for a total of six rollers 22. The brackets 23 extend far enough above the top surface of pipe 21 to ensure that when the roller 22 is mounted it has enough clearance to be able to easily rotate. Each bracket 23 has an aperture for receiving an axle bolt 24 located on opposing sides of the roller 22. The axle bolt 24 rotatably mounts the roller 22 to the bracket 23. The supporting bracket 25 is used to further reinforce and support each bracket 23 in an upright position upon the fixed member 20. The support bracket 25 is fixed between and formed at a right angle to both the top surface of the pipe 21 and the bracket 23. The support bracket 25 is used to strengthen the angle between the bracket 23 and the top surface of the pipe 21 and to provide additional structural members which stiffen the roller carriages to give it rigidity and strength under load.

The brackets 23 and the rollers 22 are formed upon the fixed member 20 such that a first parallel axis 15 passes longitudinally through the centre of each roller 22 on the fixed member 20.

Extending perpendicular from and fixed to another side of the pipe 21 of the fixed member 20 are guide arms 60 which allow the movable member 40 to move transversely towards and away from the fixed member 20 to allow different diameter workpieces 11 to be supported and rotated upon the adjustable workpiece positioning device 10.

Each guide arm 60 is a tube shaped steel pipe having a substantially square cross-sectional shape. One end the guide arms 60 is fixed to the fixed member 20 and supported at that end by the web or plate 61. The web or plate 61 acts to strengthen the angle formed between the guide arm 60 and the side surface of pipe 21 of the fixed member 20 and to provide additional structural members which provide rigidity and strength under load. Each guide arm 60 has a plurality of apertures 63 located on opposing sides of the guide arm 60. Each aperture 63 is aligned to form pairs of apertures 63 on each opposing side of the guide arms 60. The apertures 63 are adapted to receive the movable member locking pin 62 to secure the movable member 40 in place on the guide arms 60.

This allows the movable member 40 to move to different positions along the guide arms 60 and be secured in place to receive and allow the different diameter pipes 11 to be supported and rotated upon the adjustable workpiece positioning device 10.

To allow the movable member 40 to be placed upon the guide arms 60 an aperture 130 is cut in opposing sides of the movable member 40. The cut apertures are of a slightly larger size than the square cross sectional shape of the guide arms 60 this allows the movable member 40 to move easily over and along the guide arms 60. To keep the movable member 40 retained upon each guide arm 60 a stop plate 64 is fixed to an end of the guide arms 60. The stop plate 64 is of a slightly larger size than the apertures 130 formed in the movable member 40.

In order to receive the movable member locking pin 62 and secure the movable member 40 in place along the guide arms 60 a mounting flange 44 is located around the apertures 130 on the internal side of pipe 41 of the movable member 40. The mounting flange 44 has two longer opposing sides which run adjacent to corresponding sides of the guide arms 60 and have an aperture for receiving the movable member locking pin 62 therein. The movable member locking pin 62 passes through the apertures in the mounting flange 44 and corresponding apertures 63 in the guide arms 60 to secure the movable arm 40 in place on the guide arms 60.

As mentioned above a number of supporting brackets 23, 43 are fixed on each respective member 20, 40 to form the carriage support for each roller 22, 42. The brackets 43 are fixed to and extend perpendicular from the top surface of pipe 41 of the movable member 40. Each pair of brackets 43 forms a carriage to rotatably retain the rollers 42. As shown in FIGS. 1 and 2, each pair of brackets 43 is evenly spaced along the top surface of pipe 41 of the movable member 40 to form carriages for a total of six rollers 42. The brackets 43 extend far enough above the top surface of pipe 41 to ensure that when the roller 42 is mounted it has enough clearance to be able to easily rotate. Each bracket 43 has an aperture for receiving an axle bolt 45 located on opposing sides of the roller 42. The axle bolt 45 rotatably mounts the roller 42 to the bracket 43. The support bracket 46 is used to further reinforce and support each bracket 43 in an upright position upon the movable member 40. The support bracket 46 is fixed between and formed at a right angle to both the movable member 40 and the bracket 43. The support bracket 46 is used to strengthen the angle between the bracket 43 and the top surface of pipe 41 and to provide additional structural members which stiffen the roller carriages to give it rigidity and strength under load.

The brackets 43 and the rollers 42 are formed upon the movable member 40 such that a second parallel axis 16 passes longitudinally through the centre of each roller 42 on the movable member 40.

The drive unit 70 is provided to rotate the workpiece 11 on the adjustable workpiece positioning device 10. As illustrated in FIGS. 1 and 2 the drive unit 70 is operatively connected to the fixed member 20 to drive the rollers 22. In this embodiment only three of the rollers 22 mounted on the fixed member 20 for rotation around the first parallel axis 15 are being driven by the drive unit 70, the remaining three rollers 22 being non-driven rollers and rotate freely due to the connection with the workpiece 11 when the other three driven rollers 22 are rotated by the drive unit 70. Alternatively, more or less rollers 22 may be driven or non-driven rollers.

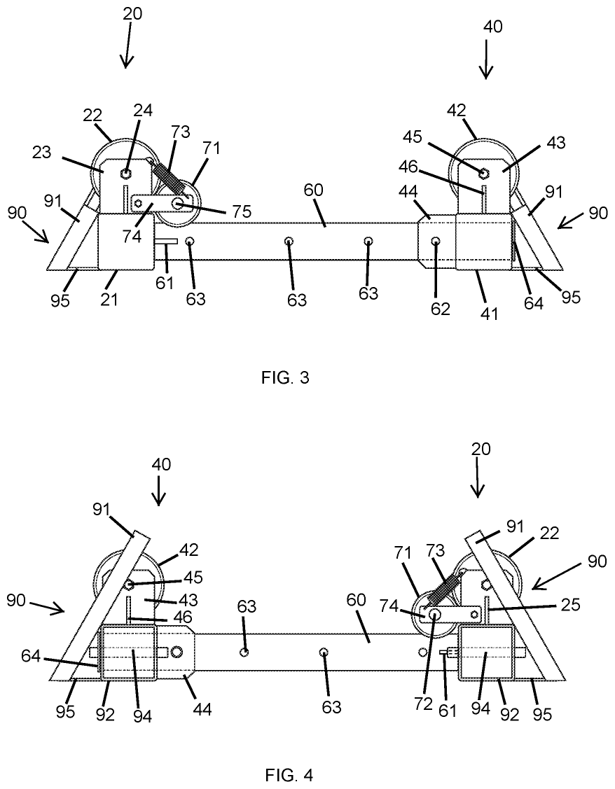

The drive unit 70 consists of the drive shaft 72, drive wheels 71 and drive attachment 75. As illustrated in FIGS. 3 and 4 the drive wheels 71 are rotatably supported by plates 74 projecting from the brackets 23 of the fixed member 20. Each drive wheel 71 is operatively connected to the respective roller 22 and held in contact with the roller 22 by springs 73. As shown the tension spring 73 is mounted between an outer edge of the bracket 23 and an outer edge of the plate 74 and on either side of the roller 22. Two springs 73 are utilised to ensure an even drive pressure is applied to the rollers 22. The drive shaft 72 is rotatably supported in each plate 74 and adapted to transmit the rotational motion from the drive end attachment 75 to each drive wheel 71 to therefore drive the rollers 22 to turn the workpiece 11. The drive shaft 72 may be supported in the plate 74 by a bearing or bush located in each plate on each side of the drive wheel 71.

The drive attachment 75 can be a socket which attaches to a socket wrench 120 or alternatively may have a pulley attached to a motor 110 by a drive belt or chain 111. The motor 110 may be powered by any one of electricity AC or DC, hydraulic fluid or air driven. Alternatively, the motor 110 may be directly driven from the drive attachment 75 without the use of a pulley and drive belt or chain 111.

As best shown in FIG. 2, the adjustable workpiece positioning device 10 has a workpiece stop mechanism 90 removably attached to an end of the fixed member 20 and the movable member 40. The workpiece stop mechanism 90 is designed to provide a stop for the workpiece 11, such that an end of the workpiece 11 butts up against the stop member 91 when it is placed on the adjustable workpiece positioning device 10. This ensures the correct positioning of the workpiece 11 on the adjustable workpiece positioning device 10. In order to provide for the various lengths of workpiece 11 which can be supported and rotated on the adjustable workpiece positioning device 10, the workpiece stop mechanism 90 can be longitudinally displaced towards and away from the ends of the fixed and movable members 20, 40. Each stop mechanism 90 is formed from longitudinally extending tube-shaped steel pipe 92 with the stop member 91 extending at an angle from and above an end of the pipe 92. The angle is in the range of 30 to 70 degrees but preferably forms an angle of 45 degrees with respect to the base 95. The pipe 92 is illustrated as having a substantially square cross-sectional shape to match the cross-sectional shape of the fixed and movable members 20, 40. The cross-sectional shape of the stop mechanism pipe 92 is slightly smaller in size than the cross-sectional size of the members 20, 40 as the pipe 92 is designed to slide into and be secured in the end of the fixed and movable members 20, 40. The longitudinal length of the workpiece stop member 90 therefore being adjustable and able to be secured in place by the stop pin 94 which is received within corresponding apertures in both the ends of the fixed and movable members 20, 40 and a plurality of apertures 93 within corresponding opposing sides of the stop mechanism pipe 92 and extending along the length of the pipe 92. The pin 94 is secured through all apertures to retain the stop mechanism 90 in position on the end of the fixed and movable members 20, 40.

FIGS. 3 and 4 show opposing end views of the adjustable workpiece positioning device 10. FIG. 3 shows the drive end view and FIG. 4 shows the workpiece stop end view. FIG. 3 best illustrates the guide arm 60 as it passes through the aperture 130 in the movable arm 40. The stop plate 64 is shown adjacent the outer side wall of the pipe 41 of the movable arm 40. In this position the adjustable workpiece positioning device 10 is at its maximum width and the movable arm 40 is secured in this position by the locking pin 62 passing through the corresponding apertures in the mounting flange 44 and the apertures 63 in the guide arm 60.

FIG. 4 best shows the workpiece stop mechanism 90 attached at an end of both the fixed and movable members 20, 40. The stop member 91 is fixed to base plate 95 which extends from and is adjacent to an outer edge of the pipe 92. As is shown the stop member 91 extends at an angle with respect to the base 95 and upwardly from the base plate 95. The stop member 91 is supported upon an upper edge of the pipe 92. Also shown is the stop pin 94 which is received within corresponding apertures in both the ends of the fixed and movable members 20, 40 and a plurality of apertures 93 within corresponding opposing sides of the stop mechanism pipe 92 and extending along the length of the pipe 92. The pin 94 is removed to extend the longitudinal length of the device 10 to suit the respective workpiece 11 to be supported and rotated on the device 10. The workpiece stop mechanism 90 is moved towards or away from the ends of the fixed and movable arms 20, 40 and the pin 94 is then replaced in the corresponding apertures.

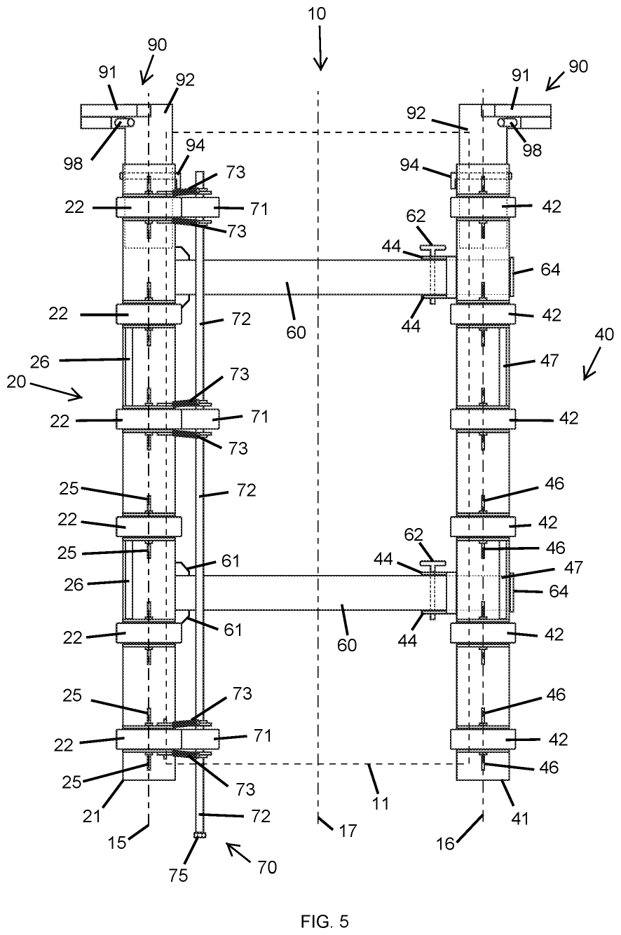

FIG. 5 is a plan view from above of the adjustable workpiece positioning device 10. As is best illustrated the first parallel axis 15 passing longitudinally through the centre of each roller 22 on the fixed member 20 and the second parallel axis 16 passes longitudinally through the centre of each roller 42 on the movable member 40. The workpiece 11 also is shown with the longitudinal axis 17 passing through the centre of the workpiece 11. All three axes 15, 16 and 17 are located in a parallel relationship to each other, with the first and second axes 15, 16 being spaced apart and located equidistantly from the longitudinal axis 17 of the workpiece 11. This relationship is always maintained as the movable member 40 moves towards and away from the fixed member 20 on the guide arms 60.

Also illustrated in FIG. 5 are the adjacent roller support braces 26, 47 located between the middle four rollers 22, 42 on both the fixed and movable members 20, 40. These braces 26, 47 simply reinforce and strengthen adjacent roller carriages to give further rigidity and strength under load. The braces 26, 47 also allow a user to pick up the adjustable workpiece positioning device 10 with a forklift or pallet forks. The user simply locates the forks of the fork lift within the space formed between the braces 26, 47 and the top of the respective fixed and movable members 20, 40.

FIGS. 6 to 9 show an enlarged detail of the drive wheel 71 attachment to the roller 22 on the fixed member 20. As described above each drive wheel 71 is rotatably mounted adjacent and operatively connected to the roller 22 by the combination of plates 74 and tension springs 73 located on each side of the roller 22. The plates 74 are fixed to the brackets 23 at a lower inside edge adjacent the top of the pipe 21. The plates 74 extend horizontally away from the longitudinally extending pipe 21 and bracket 23. As is illustrated the plate 74 is fixed to the bracket 23 by fastener 78, however any other type of known fixing device could be used to secure the plate 74 to the bracket 23. The tension spring 73 is mounted between an outer edge of the bracket 23 and an outer edge of the plate 74 and on either side of the roller 22. At one end the spring 72 is mounted to the ring 76 located on an upper peripheral edge of the bracket 23. At the opposing end the spring 73 is mounted through the aperture 77 located on an outer edge of the plate 74. The springs 73 are designed to provide tension to the drive wheel 71 against the rollers 22. As shown two springs 73 are utilised to ensure an even drive pressure is applied to the rollers 22. The drive shaft 72 is rotatably supported in each plate 74 and adapted to transmit the rotational motion from the drive end attachment 75 to each drive wheel 71 to therefore drive the rollers 22 to turn the workpiece 11. Alternatively, only one spring 73 may be used on each roller 22. The drive shaft 72 extends substantially parallel with the pipe 21 of the fixed member 20, it is also therefore aligned parallel with the first axis 15 passing through the rollers 22 on the fixed member 20.

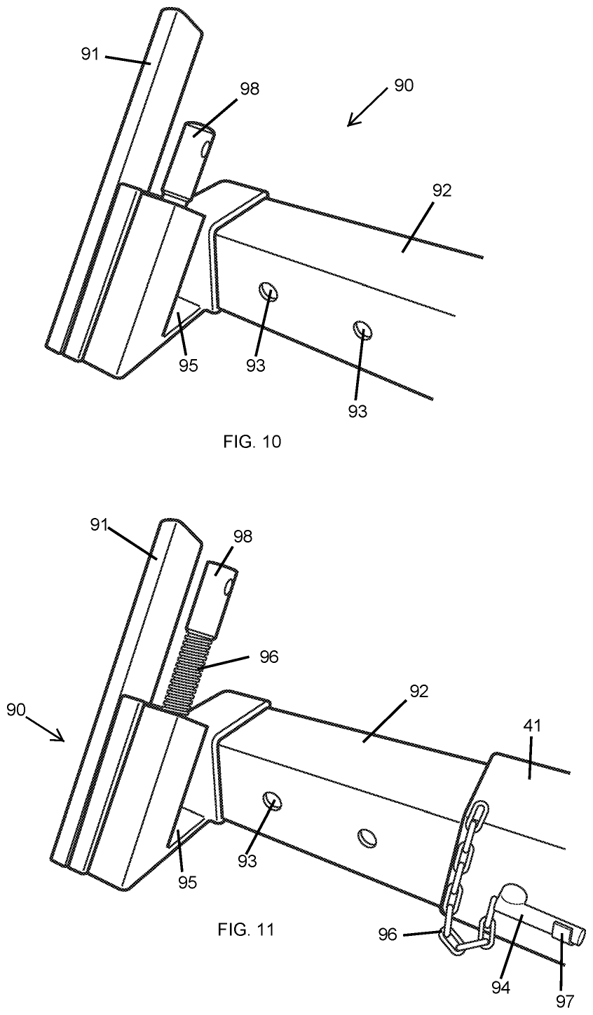

FIGS. 10 and 11 show enlarged detail of the workpiece stop mechanism 90 attached to the end of the movable member 40. While the enlarged detail is shown only on the movable member 40 the corresponding stop mechanism 90 located on the fixed member 20 is identical. As described above the cross-sectional shape of the stop mechanism pipe 92 is slightly smaller in size than the cross-sectional size of the movable member pipe 41 as the pipe 92 is designed to slide into and be secured in the end of the movable member 40. The longitudinal length of the workpiece stop member 90 therefore being adjustable and able to be secured in place by the stop pin 94 which is received within corresponding apertures in the ends of the movable member 40 and a plurality of apertures 93 within corresponding opposing sides of the stop mechanism pipe 92 and extending along the length of the pipe 92. The pin 94 is secured through all apertures to retain the stop mechanism 90 in position on the end of the movable member 40. The pin 94 is attached to an end of a chain 96 to avoid loss of the pin 94 on the worksite. When positioned within the apertures 93 and corresponding apertures in the movable member pipe 41 the end of the pin 94 is retained within plate or stirrup 97.

When the adjustable workpiece positioning device 10 is used with concrete pipes that have an enlarged or bell end attachment the workpiece stop 90 also has an adjustable arm or spigot 98. The adjustable arm 98 has a screw thread 96 which can be screwed into or out of the base 95 to accommodate the bell end of the pipe. The base 95 has a corresponding internal screw thread which receives the screw thread 96. The adjustable arm 98 is therefore able to move in or out or be screwed in our out of the base 95 to rest against the bell shaped end of the workpiece 11.

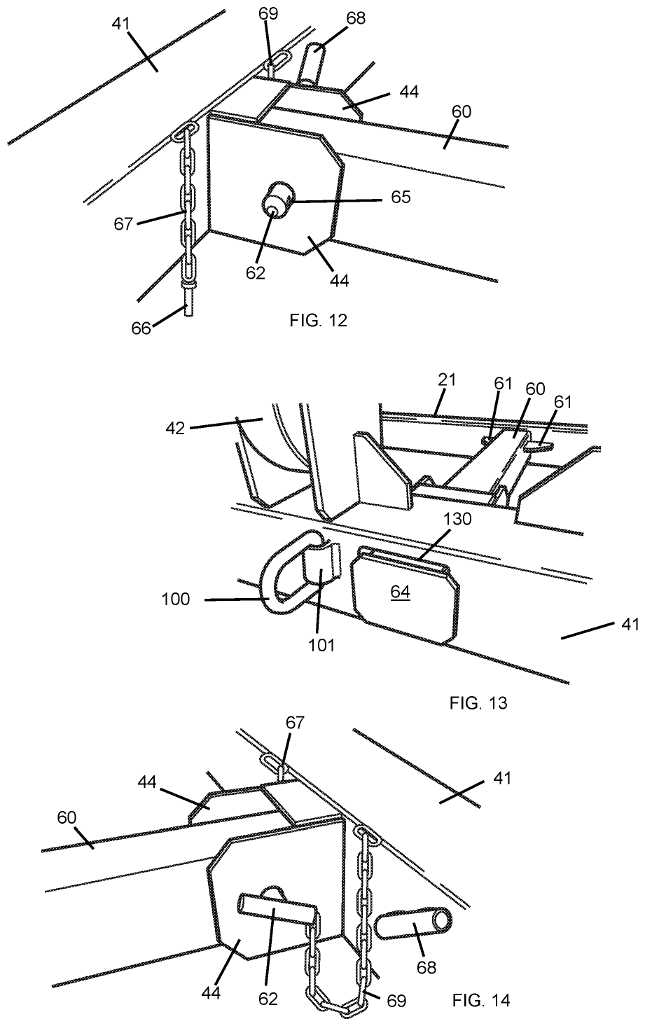

FIGS. 12 to 14 illustrate the connection between the guide arms 60 and the fixed and movable members 20, 40. FIG. 12 shows an enlarged view of the flange 44 surrounding the aperture 130 located on the internal side of the movable member pipe 41 and the guide arm 60 which passes through the aperture 130. In order to secure the movable member 40 on the guide arm 60 the locking pin 62 passes through apertures in both sides of the flange 44 and the apertures 63 in the guide arm 60. At one end the pin 62 is secured by the lock pin 66 attached to chain 67 fixed on the internal edge of the pipe 41. The lock pin 66 passes through the slot 65 in the end of the locking pin 62 once the locking pin 62 is positioned in place through all of the apertures in the flange 44. This also ensures that the locking pin 62 cannot be inadvertently removed while the workpiece 11 is located on the adjustable workpiece positioning device 10.

FIG. 13 shows the end stop plate 64 attached to the end of the guide arm 60. The end stop plate 64 provides a stop for the movable member pipe 41 on the guide arm 60. Also shown in FIG. 13 is the lifting point having a load ring 100 and mounting attachment 101 located on an outer side of the movable member pipe 41. The mounting attachment 101 allows the load ring 100 to be pivotally mounted on the outer side of the movable member pipe 41. Typically two lifting points are located on the movable member 40 and the fixed member 20. The lifting points allow the adjustable workpiece positioning device 10 to be picked up by a fork lift or crane and positioned on a worksite for use.

FIG. 14 shows the locking pin holder 68 mounted on an inside wall of the movable member 40. The locking pin 62 is attached to chain 69 with an end of the chain 69 fixed to an edge of the movable member pip 41. When not in use the locking pin 62 is placed into the holder 68.

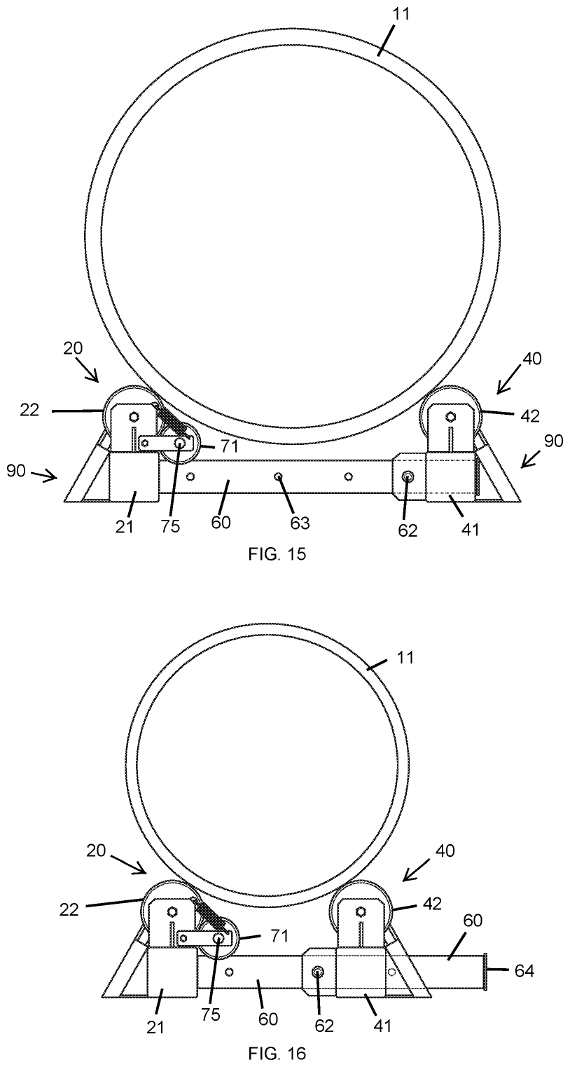

FIGS. 15 and 16 show the adjustable workpiece positioning device 10 with two different diameter pipes 11 supported for rotation. FIG. 15 shows a pipe 11 with the movable member 40 secured at the extremity of the guide arm 60. In this position an outer side of the movable member 40 is abutted against the end stop 64 of the guide arm 60. In FIG. 16 a smaller diameter pipe 11 is mounted for rotation with the movable member 40 moved to a position along the guide arm 60 such that a portion of the guide arm 60 and the guide arm stop 64 is located outside of and to the right of the movable member 40. In this position the locking pin 62 secures the movable member 40 in a different position than that indicated above in FIG. 15. This illustrates the ability of the present invention to accommodate different diameter workpieces 11.

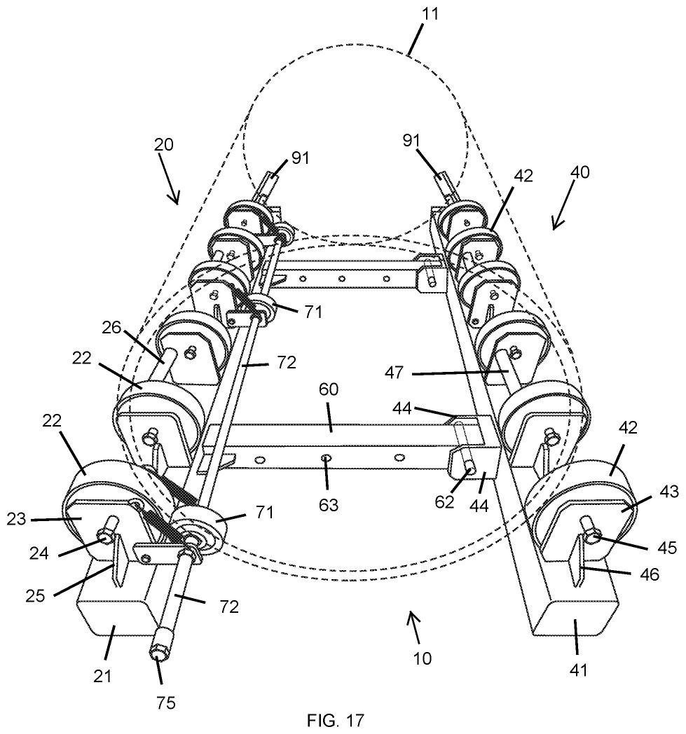

FIG. 17 shows a perspective drive end view of the adjustable workpiece positioning device 10 of FIG. 15. The positioning of the workpiece 11 is shown symmetrically located on the device 10 with an end abutted against the workpiece stop arm 91.

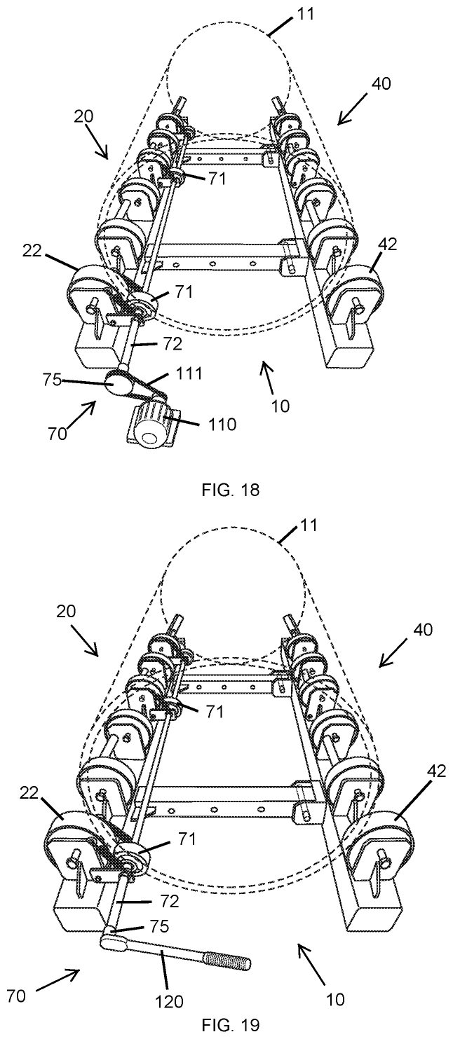

FIGS. 18 and 19 illustrate two methods of driving the drive unit 70 for the adjustable workpiece positioning device 10. FIG. 18 shows the connection to the drive end attachment 75 of a pulley to which is attached the chain or belt 111 and the electric motor 110. As described above the present invention is not only limited to an electric motor drive and could be replaced by either a hydraulic or pneumatic driven system. FIG. 19 shows the connection to the drive end attachment 75 of a socket and socket wrench 120. In this configuration the socket wrench 120 is manually driven by a user. Other known methods of driving the device 10 are not excluded from the present invention.

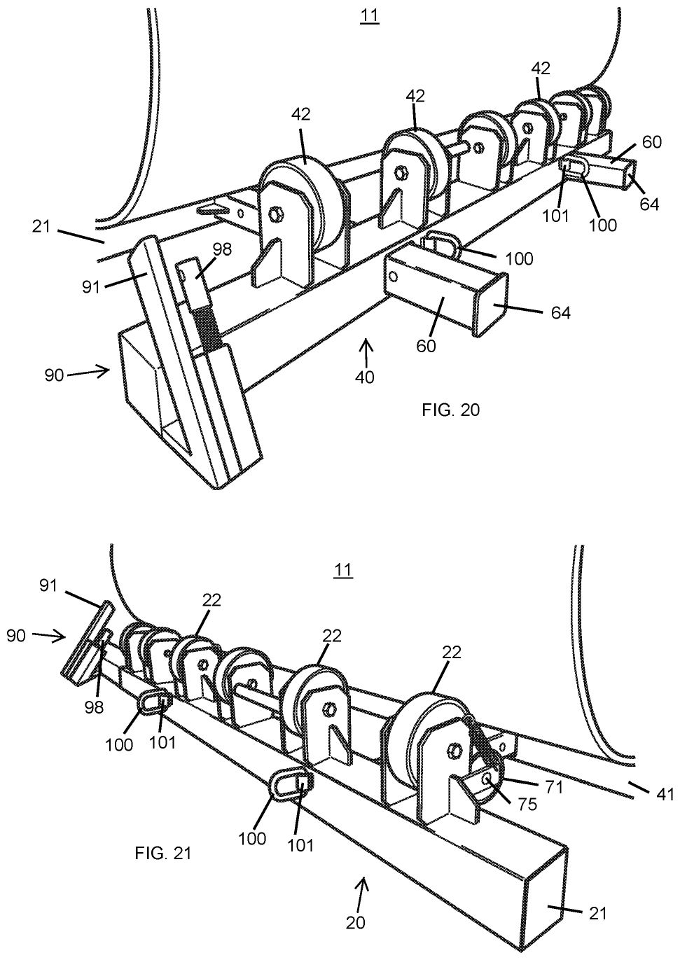

FIGS. 20 and 21 show both side perspective views of the adjustable workpiece positioning device 10 as shown in the end view of FIG. 16. FIG. 20 shows the smaller diameter pipe 11 is mounted for rotation with the movable member 40 moved to a position along the guide arm 60 such that a portion of the guide arm 60 and the guide arm stop 64 is located outside of and to the right of the movable member 40. Also shown in FIG. 20 are the two lifting points with load rings 100 and mounting attachments 101 located on the outer side of the movable member pipe 41 of the movable member 40. Likewise, FIG. 21 shows two lifting points located on the outer side of the fixed member pipe 21 of the fixed member 20. The lifting points can also be utilised to secure or tie down the workpiece 11 to the adjustable workpiece positioning device 10. This is particularly advantageous when the device 10 is required to be positioned or moved around the worksite. It also allows a workpiece 11 to be secured to the adjustable workpiece positioning device 10 during transport to or from a worksite.

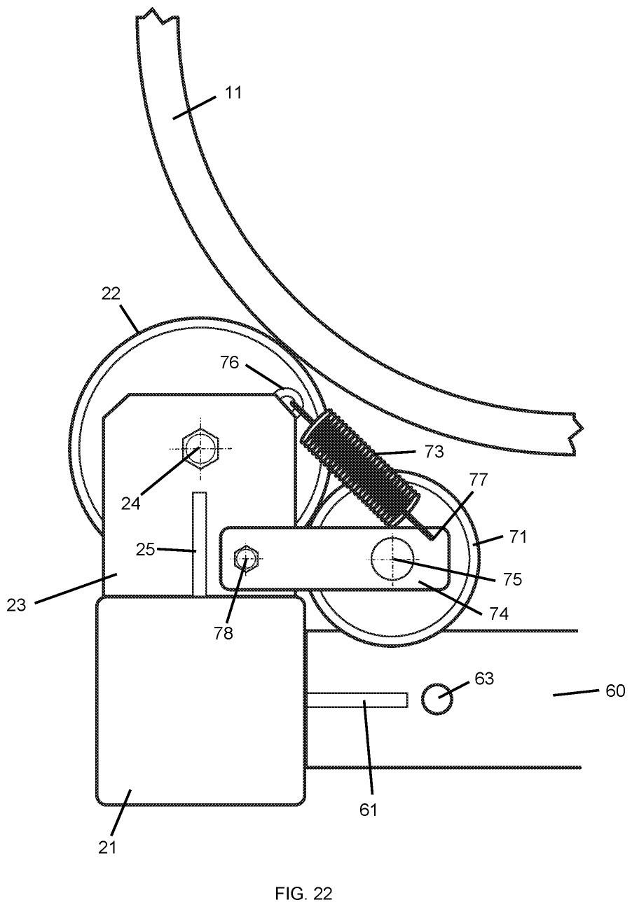

FIG. 22 illustrates an enlarged end view of the fixed member 20 and roller 22 with a section of workpiece 11 supported for rotation on the device 10. Shown here is the contact of the workpiece 11 on the roller 22 and the positioning of the drive wheel 71 held under spring tension against the roller 22. In use, the drive attachment 75 drives the drive wheel 71 in a clockwise direction, at the same time this causes the roller 22 on the fixed member 20 to rotate in an anti-clockwise direction thereby causing the workpiece 11 to rotate in a clockwise direction. Likewise, if the drive attachment 75 drives the drive wheel 71 in an anti-clockwise direction the roller 22 on the fixed member 20 will rotate in a clockwise direction thereby causing the workpiece 11 to rotate in an anti-clockwise direction.

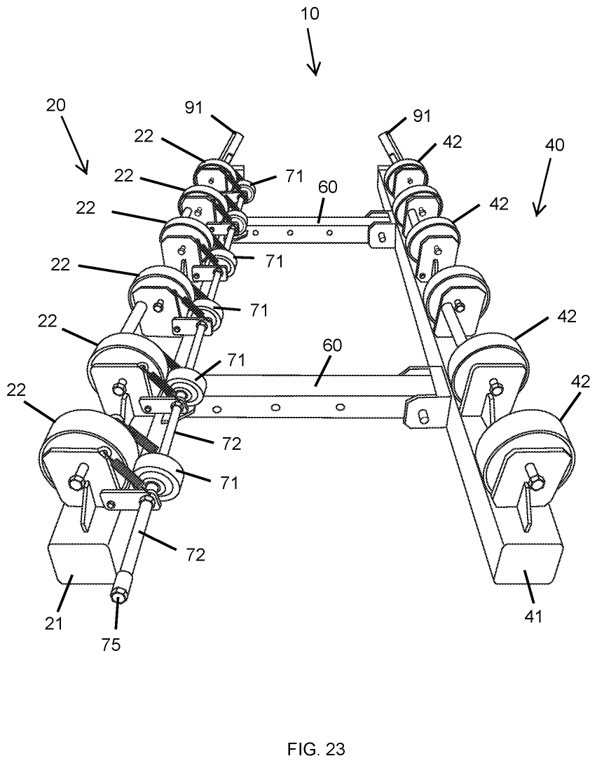

FIG. 23 shows a further embodiment of the present invention of the adjustable workpiece positioning device 10 in which a drive wheel 71 is located to drive each one of the rollers 22 on the fixed arm 20. Like the previously described drive unit 70 the only difference being that each one of the rollers 22 are driven individually by a drive wheel 71.

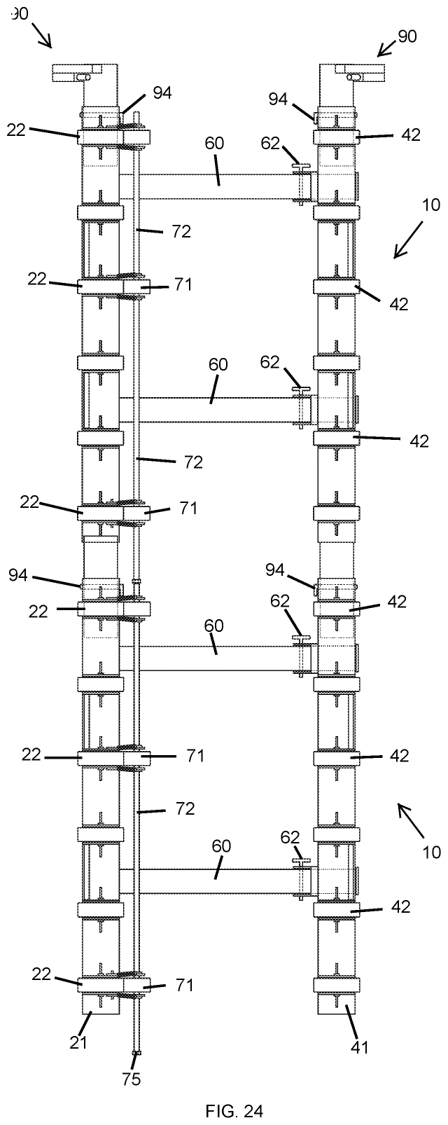

FIG. 24 shows a further embodiment of the present invention of the adjustable workpiece positioning device 10. In order to accommodate extended lengths of longitudinally extending workpieces 11 two devices 10 can be joined to form a double length adjustable workpiece positioning device 10. In order to join the two adjustable workpiece positioning devices 10, the bottom device 10 has the workpiece stop mechanism 90 removed and an attachment arm is inserted and secured within the ends of the fixed and movable members 20, 40. Likewise, the drive shaft 72 on the bottom device 10 is joined to the corresponding drive shaft 72 on the top device 10 so that only the bottom device 10 is required to be driven in order to rotate all of the rollers 22 on the fixed member 20. For example, a socket extension piece can be inserted into the respective ends of the drive shaft 72 to join both drive shafts 72 to enable a single drive motor to rotate the workpiece 11 of the adjustable workpiece positioning device 10.

The present invention has been primarily designed to support and rotate concrete pipe workpieces 11 at the worksite. As described above these concrete workpieces 11 can weigh from 200 kg up to more than 8000 kg and have a diameter from 200 mm up to more than 3000 mm. In order to safely support and rotate such a workpiece 11 the materials from which the respective components of the device 10 can be manufactured are limited. In particular, the fixed and movable members 20, 40, the guide arms 60, the brackets 23, 43 for the roller carriages, and associated reinforcing components are all typically manufactured from steel or a like metal. When the adjustable workpiece positioning device 10 is used on such workpieces as metal, glass or plastic pipes the above components can be manufactured from more lightweight materials such as aluminum or high strength plastics. The overall weight requirement of the workpiece 11 will dictate the materials from which the adjustable workpiece positioning device 10 is manufactured, or alternatively the load requirement that the device 10 is designed to handle will dictate the materials used to manufacture the device 10.

The rollers 22, 42 can be selected from any one of a cast iron or steel caster wheels, a cast iron or steel wheel, a polyurethane plastic wheel or a urethane on cast iron wheel. By way of example only, cast iron wheels have a high capacity, a low rolling resistance and excellent heat resistance. Likewise when lower loads are required the wheels or rollers 22, 42 may be a polyurethane plastic or like material. Likewise the drive wheels 71 may be polyurethane on cast iron wheel or polyurethane plastic material or the like.

Given that most of the materials utilised to manufacture the adjustable workpiece positioning device 10 are metal the main fixing of one material to another is by welding. For example, the brackets 23, 43 are fixed to the fixed and movable members 20, 40 by welding or similar process. Likewise, the reinforcing plates and brackets are also fixed by welding. While other methods of fixing are available when utilised to support and rotate large diameter concrete pipes the most effective fixing of one component to another is by welding.

The positioning of the rollers 22, 42 are such that there axes of rotation is oriented perpendicular to the first and second axes 15, 16 passing longitudinally through the centre of each roller 22, 42 on the fixed and movable members 20, 40.

While not illustrated the rollers 22, 42 on the fixed and movable members 20, 40 may also have at least one of the rollers fitted with a mechanical stop or lock device. For example, one of the rollers 22, 42 on either the fixed or movable members 20, 40 may have a mechanical brake to stop the rollers 22, 42 from travelling unnecessarily. This may also function to prevent the workpiece 11 from rotating when the work is being carried out on the workpiece 11.

### Advantages

A number of advantages are apparent in the present invention. The present invention provides an adjustable workpiece positioning device that can be transported to the worksite and is easy to set up at the worksite. The ability to be able to change the position of the movable arm with respect to the fixed arm allows the user to utilise the present invention to suit a number of different diameter workpieces of varying lengths.

The present invention has been designed to support and turn concrete, steel, PVC or other structural material posts or pipes to allow a user to machine the post or pipe. In particular, the device has been devised to allow a user to turn a concrete post or pipe of a diameter of between 20 cm to 2.0 m and of any length up to 2.4 m long to enable the user to perform such tasks as drilling, cutting welding or chamfering of the concrete post or pipe.

The positioning of the rollers on the fixed and movable arms, with each roller orientated such that the axis of rotation of each roller is located substantially parallel with an axis passing longitudinally through each arm ensures that the pipe or post to be rotated between the fixed and movable arms is ideally positioned with the longitudinal axis passing through the workpiece always being positioned centrally between the fixed and movable members.

The lifting points located on both the fixed and movable members allows the device to be easily moved into position at the worksite and also allows the workpiece to be easily secured to the device if required to be moved around the worksite.

The present invention also allows more than one adjustable workpiece positioning device to be joined together to form an extended length device suitable for supporting and rotating workpieces of longer length. For example two or more adjustable workpiece positioning devices could be joined in an end to end relationship to allow a pipe of between 4.8 m to 8.0 m in length to be supported and rotated.

### Variations

It will be realized that the foregoing has been given by way of illustrative example only and that all other modifications and variations as would be apparent to persons skilled in the art are deemed to fall within the broad scope and ambit of the invention as herein set forth.

As used herein the term “and/or” means “and” or “or”, or both.

As used herein “(5)” following a noun means the plural and/or singular forms of the noun.

In this specification, adjectives such as first and second, left and right, top and bottom, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the scope of the above described invention.

In the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

What is claimed is:

1.-39. (canceled)

40. An adjustable workpiece positioning device for rotatable support of elongate workpieces to be worked, the device comprising:
a longitudinally extending base frame having a fixed member and a movable member being disposed in generally parallel and spaced relation;
a plurality of adjacent pairs of rollers journaled on the fixed and movable members to rotatably support the elongated workpieces axially parallel to the rollers between the fixed and movable members, each adjacent pair of rollers having one roller on the fixed member and one roller on the movable member; and
a means for moving the movable member in a transverse relationship with respect to the fixed member to increase or decrease a space between the fixed and movable members, thereby permitting the workpieces of varying diameter to be rotatingly supported by the plurality of rollers, the means comprising:
a pair of arms extending perpendicular from the fixed member; and
a pair of apertures in the moveable member, each aperture is adapted to receive therein one of the pair of arms extending perpendicular from the fixed member.

41. An adjustable workpiece positioning device as claimed in claim 40, wherein the plurality of rollers on the fixed member rotate about a first parallel axis and the plurality of rollers on the movable member rotate about a second parallel axis, the first and second parallel axes are positioned each side of and running parallel with the longitudinal axis.

42. An adjustable workpiece positioning device as claimed in claim 41, wherein each one of the plurality of rollers is mounted to freely rotate in a position located substantially above each of the fixed and movable members.

43. An adjustable workpiece positioning device as claimed in claim 42, wherein each roller mounting comprises a pair of spaced apart mounting plates forming a carriage for the rollers, each mounting plate having a central aperture for receiving an axle bolt for rotatably mounting the roller to the mounting plates.

44. An adjustable workpiece positioning device as claimed in claim 43, wherein at least one of the plurality of rollers has a manually operable roll brake for stopping rotation of the roller, the roll brake allowing the selective positioning of the elongate workpiece being rotatably supported thereon.

45. An adjustable workpiece positioning device as claimed in claim 40, further comprising a drive unit operatively connected to one of the plurality of rollers, the drive unit permitting the workpiece to be rotated about a longitudinal axis while being supported on the plurality of rollers.

46. An adjustable workpiece positioning device as claimed in claim 45, wherein the drive unit further comprises at least one drive wheel and an associated drive shaft connected to at least one of the plurality of rollers on the fixed member, the drive wheel is operatively connected to the roller by at least one tensioning device mounted between the roller mounting and a drive wheel mounting plate, and the tensioning device is a tension spring.

47. An adjustable workpiece positioning device as claimed in claim 46, wherein each one of the plurality of rollers on the fixed member has an operatively connected drive wheel and associated common drive shaft which interconnects each drive wheel of the drive unit.

48. An adjustable workpiece positioning device as claimed in claim 47, wherein the drive shaft is rotatably supported in the drive wheel mounting plate of each drive wheel, and the drive unit drive shaft has a drive attachment mechanism located on one end of the drive shaft.

49. An adjustable workpiece positioning device as claimed in claim 48, wherein the drive attachment mechanism is adapted to be mechanically driven permitting the workpiece to be rotated about the longitudinal axis while being supported on the plurality of rollers, the mechanical drive is an electric, pneumatic or hydraulic motor.

50. An adjustable workpiece positioning device as claimed in claim 49, wherein the drive attachment mechanism is a socket for receiving a socket wrench to allow a user to manually drive the drive unit permitting the workpiece to be rotated about the longitudinal axis while being supported on the plurality of rollers.

51. An adjustable workpiece positioning device as claimed in claim 40, wherein the means for moving the movable member further comprises a plurality of apertures extending along the length of each arm and adapted for receiving a locating pin to be secured through a corresponding aperture in the movable member, the movable member is adapted to be fixed in positions by the locating pin.

52. An adjustable workpiece positioning device as claimed in claim 51, wherein the movable member further comprises a mounting flange extending around each aperture, the mounting flange having an aperture located in opposing sides of the flange adapted to receive the locating pin to secure the movable member in position on the pair of arms extending from the fixed member.

53. An adjustable workpiece positioning device as claimed in claim 40, wherein the adjustable workpiece positioning device further comprises a workpiece stop member extending from an end of the fixed and/or movable members, the workpiece stop member being adapted to engage an end of the elongate workpiece to ensure the workpiece is correctly positioned on the device.

54. An adjustable workpiece positioning device as claimed in claim 53, wherein a length which the workpiece stop member extends from the end of the fixed and/or movable members is adjustable.

55. An adjustable workpiece positioning device as claimed in claim 54, wherein the workpiece stop member further comprises a height adjustable spigot adapted to support a flanged end of the elongate workpiece, the spigot has a threaded shaft which is received within a threaded socket of the workpiece stop member and is adapted to be screwed in and out to accommodate different sized flanged ends.

56. An adjustable workpiece positioning device as claimed in claim 40, wherein the adjustable workpiece positioning device further comprises at least one lifting point attached to the fixed and/or movable members, the lifting points comprise a load ring fixedly attached to the fixed and/or movable members.

57. An adjustable workpiece positioning device as claimed in claim 40, wherein the elongate workpiece has a substantially circular cross-section, and the elongate workpiece is selected from any one of a ceramic pipe, a glass pipe, a fiberglass pipe, a metal pipe, a concrete pipe or a plastic pipe.

58. An adjustable workpiece positioning device as claimed in claim 57, wherein the elongate workpiece is a concrete pipe having a weight in the range of 200 kg up to more than 8000 kg, having a diameter from 200 mm up to more than 3000 mm and are provided in a length of approximately 2.4 m.

59. An adjustable workpiece positioning device for rotatable support of extended elongate workpieces to be worked, the device comprising:
a first adjustable workpiece positioning device comprising:
a longitudinally extending base frame having a fixed member and a movable member being disposed in generally parallel and spaced relation;
a plurality of rollers journaled on the fixed and movable members to rotatably support the elongated workpieces axially parallel to said rollers between the fixed and movable members;
a means for moving the movable member in a transverse relationship with the fixed member to increase or decrease a space between the fixed and movable members, thereby permitting the workpieces of varying diameters to be rotatingly supported by the plurality of rollers, the means comprising:
a pair of arms extending perpendicular from the fixed member; and
a pair of apertures in the moveable member, each aperture is adapted to receive therein one of the pair of arms extending perpendicular from the fixed member; and
a drive unit operatively connected to one of the plurality of rollers, the drive unit permitting the workpiece to be rotated about a longitudinal axis while being supported on the plurality of rollers;
a second adjustable workpiece positioning device comprising:
a longitudinally extending base frame having a fixed member and a movable member being disposed in generally parallel and spaced relation;
a plurality of rollers journaled on the fixed and movable members to rotatably support the elongated workpieces axially parallel to said rollers between the fixed and movable members;
a means for moving the movable member in a transverse relationship with the fixed member to increase or decrease a space between the fixed and movable members, thereby permitting the workpieces of varying diameters to be rotatingly supported by the plurality of rollers, the means comprising:
a pair of arms extending perpendicular from the fixed member; and
a pair of apertures in the moveable member, each aperture is adapted to receive therein one of the pair of arms extending perpendicular from the fixed member; and
a drive unit operatively connected to one of the plurality of rollers, the drive unit permitting the workpiece to be rotated about a longitudinal axis while being supported on the plurality of rollers; and
a connecting member to join the first and second adjustable workpiece positioning devices in an end to end relationship.
